(19) United States
(12) Patent Application Publication
(10) Pub. No.: US 2016/0112829 A1
(43) Pub. Date: Apr. 21, 2016

(54) METHOD AND SYSTEM FOR PERMISSIONS BASED CONTENT BROADCASTING

(71) Applicant: StoryCloud, Inc., San Diego, CA (US)

(72) Inventors: Kenneth J. KALB, Solana Beach, CA (US); Michael W. Tracy, Solana Beach, CA (US); Barry Shapira, Solana Beach, CA (US)

(21) Appl. No.: 14/515,393

(22) Filed: Oct. 15, 2014

(51) Int. Cl. H04W 4/02; H04L 29/08

(52) U.S. Cl. CPC H04W 4/02; H04L 67/18

(57) ABSTRACT

Some aspects of the content broadcasting service provide a method and system that maintains content and associated geographic information. The method and system receives a geographic location of a device. The method and system enables access of the content to the device based on the geographic information and geographic location of the device.

### BACKGROUND

With the proliferation of social media services, content sharing has become increasingly prevalent among internet users. Typically, content is posted to a social media service and “shared” by other users. Content posters may set certain permissions that are specific to groups that are capable of accessing and/or sharing content. For instance, a content poster may limit content sharing to only those users that the poster knows (e.g., friends as defined by the social media service), or to a particular subset of users that the poster knows. Current social media services provide no mechanism for limiting users based on other permissions such as geographic location or demographics. Moreover, when content is “shared,” a permanent instance of the content is created and stored at the social media service. Thus, when the poster wishes to remove the content, he can never fully trust that the content is completely removed because other permanent instances may exist elsewhere in the social media service.

### SUMMARY

Some aspects of the disclosure provide a permissions based content broadcasting service that enables granular control of content based on time, geo-location and demographics. When providing content to the content broadcasting service, the device providing the content may also set certain permissions specifying with who can access the content. The permissions may exclude certain devices that are outside of a particular geographic radius or are used by users who do not fit a particular set of demographics.

Some aspects of the content broadcasting service provide the capability to place advertisements that may be associated with a cost corresponding to a pricing scale associated with activity in a geographic location. The pricing scale may change according to the permissions, size of the geographic location, and activity in the area.

It is understood that other aspects of processes and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### DESCRIPTION OF THE FIGURES

Various aspects of apparatuses and processes will now be presented in the detailed description by way of example, and not by way of limitation, with reference to the accompanying drawings, wherein:

FIG. 1 illustrates an exemplary display on a mobile device that may provide access to content provided by the content broadcasting service.

FIG. 2 illustrates an exemplary display of information associated with content that may be accessed.

FIG. 3 conceptually illustrates a process for providing content to different users based on a geographic location.

FIG. 4 illustrates an exemplary display on a mobile device for providing content to the content broadcasting service.

FIG. 5 conceptually illustrates a process for providing content to the content broadcasting service.

FIG. 6 illustrates an exemplary display of a mobile device that is communicatively connected to the content broadcasting service.

FIG. 7 illustrates an example display of a mobile device for setting different parameters or criteria defining which users of the content broadcasting service are able to access the content.

FIG. 8 conceptually illustrates a process for providing content to the content broadcast service.

FIG. 9 conceptually illustrates a process for providing content to a mobile device that satisfies predefined criteria.

FIG. 10 illustrates an exemplary mobile device having a display.

FIG. 11 illustrates an exemplary mobile device having a display for placing a targeted advertisement using the content broadcasting system.

FIG. 12 conceptually illustrates a process for providing content to the content broadcasting service.

FIG. 13 illustrates an exemplary configuration of a content broadcasting server.

FIG. 14 illustrates an exemplary computer system that may implement the content broadcasting server.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” of an apparatus, method or article of manufacture does not require that all embodiments of the invention include the described components, structure, features, functionality, processes, advantages, benefits, or modes of operation.

Some aspects of the disclosure provide a process for sharing content with different users of a content broadcasting service. The content broadcasting service provides the content to the different users based on geography. For instance, certain content may be associated with a geographic location and accessible only by mobile devices that are within a certain geographic region. Furthermore, content provided to the content broadcasting service is only maintained on a content broadcasting server. For example, when another user of the content broadcasting service wishes to access the content, the content broadcasting server may provide the content to a client device for viewing, but not storing the content. Thus, content is only transferred from a client device to the content broadcasting service, but not to other client devices for purposes beyond viewing the content. Therefore, when a user removes content that he provided to the content broadcasting service, no other client device will be able to access the content. It follows, that although content is “provided” throughout this disclosure to different client devices, only a temporary instance of the content (and not the content itself) is actually provided for the purposes of viewing the content on other client devices that are capable of accessing the content broadcasting service.

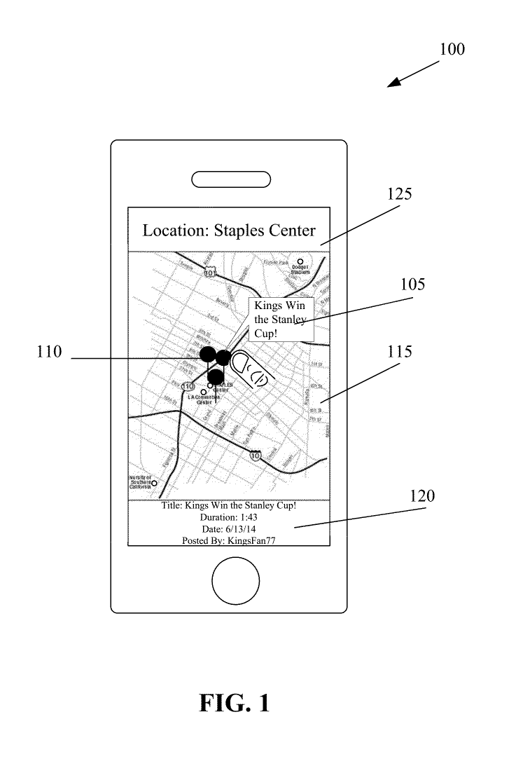

FIG. 1 illustrates an exemplary display on a mobile device 100 that may provide access to content provided by the content broadcasting service. The content may be stored on and provided by a content broadcasting server. As shown, the mobile device display includes a location indicator 125, content location identifier 110, content descriptor 120, map display 115, and content title 105.

The map display 115 provides a general geographic location of the mobile device 100. The location indicator 125 provides more detailed information of the location of the mobile device. For instance, the map 115 shows a view of part of downtown Los Angeles, which includes various attractions such as the Staples Center arena. In this exemplary display, the mobile device 100 is located somewhere in or around the Staples Center as indicated by the location identifier 125.

As shown in FIG. 1 several different contents are accessible to the user. Such content may be indicated by a visual indicator such as a graphical push pin at different locations on map 115. The locations of the push pins may provide an indication of where the mobile device that uploaded the content was located when the content broadcasting service received the content. In this exemplary display, a content was received from a mobile device located at the Staples Center and is accessible to mobile device 100. The content is indicated, in this example, by content location identifier 110. In this example, when the mobile device receives a gesture, such as a tap on or around the content location identifier 110, the mobile device displays content title 105 in the map display 115, and content description 120.

The display illustrated in FIG. 1 is one example of a possible display of a mobile device that has access to the content broadcasting service. However, different configurations of the display are possible and access to the content broadcasting. Additionally, the content location identifier illustrated in FIG. 1 is in the shape of a push pin, but different visual indicators may be used without changing the functionality of the mobile device 100.

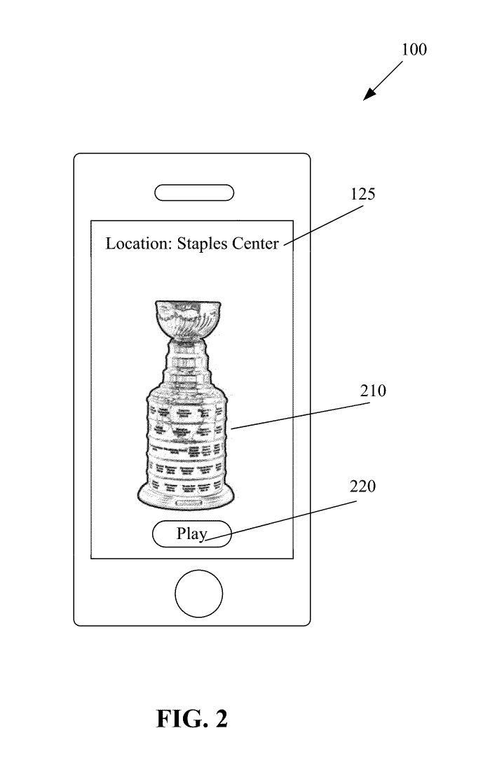

Upon selecting a content location identifier such as content location identifier 110, the content broadcasting service may provide information to display the content associated with the content location identifier. For instance, FIG. 2 illustrates an exemplary display of information associated with content that may be accessed. FIG. 2 includes content display 210 and selectable user interface (UI) object 220. UI object 220 may, in some aspects of the content broadcast service be a selectable button. Content display 210 may be a frame of a video content that has been associated with the content location identifier 110, for example. Upon selection of selectable UI object 220, a video may replace the frame displayed in content display 210. The video may be played in content display 210 so that a user of the content broadcasting service can view the video. Some aspects of the content broadcasting service may provide an option for users to post comments about the content. Such comments may be input upon selecting a selectable UI object (not shown) to input the comment and then transmit the comment to the content broadcasting service.

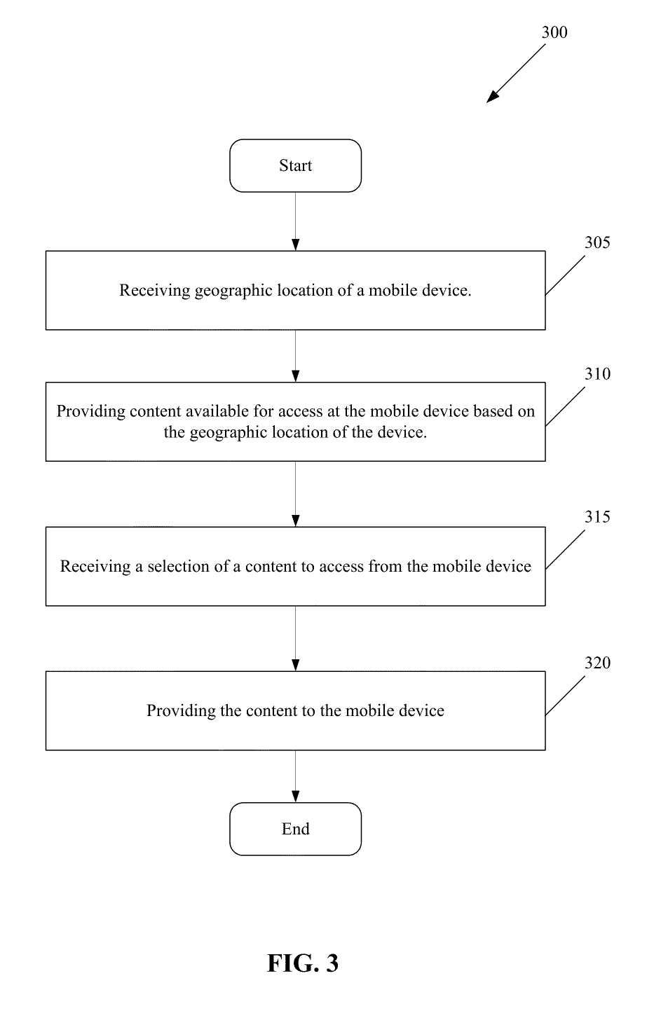

FIG. 3 conceptually illustrates a process 300 for providing content to different users based on a geographic location. The process 300 may be performed by a content broadcasting server. The process 300 may begin after a user has accessed the content broadcasting service through a mobile device.

As shown, the process 300 receives (at 305) a geographic location of a mobile device. The process then provides (at 310) content available for access by the mobile device based on the geographic location of the device. The content may have geographic constraints relating to the proximity of the device to a geographic location associated with the mobile content. For instance, the content broadcast service may have a default setting that only allows users located within a 5 mile radius of a location associated with a content to access the content. However, in some aspects of the content broadcast service, limiting access may be a customizable option with several different options. In such aspects, the content broadcasting service may limit access to only a particular behavioral patterns or a specified time frame. Particularly, the content may only be accessible user during a specified time frame. Users of the content broadcast service within geographic range of the content may be incapable of accessing the outside of the specified time frame. In some aspects of the content broadcast service, a visual representation of the content may be displayed, but when the user attempts to access the content, a message may appear indicating that the content is not yet, or no longer, accessible. In other aspects of the content broadcast service, a visual representation of the content may only appear during the specified time frame. Additionally, access to the content may be limited to devices that have first performed certain specified actions (e.g. behavioral patterns).

The process 300 receives (at 315) a selection of a content to access from the mobile device. In some aspects of the content broadcast service, accessing the content may include viewing or manipulating the content. The process provides (at 320) the content to the mobile device. For instance, the process 300 may provide a temporary instance video or image to the device for viewing on the device. The mobile device may only access the content through the content broadcasting service. Particularly, the content is not permanently stored on the mobile device or accessible when the device is communicating with the content broadcasting service. Once content is provided to the mobile device, the process 300 ends.

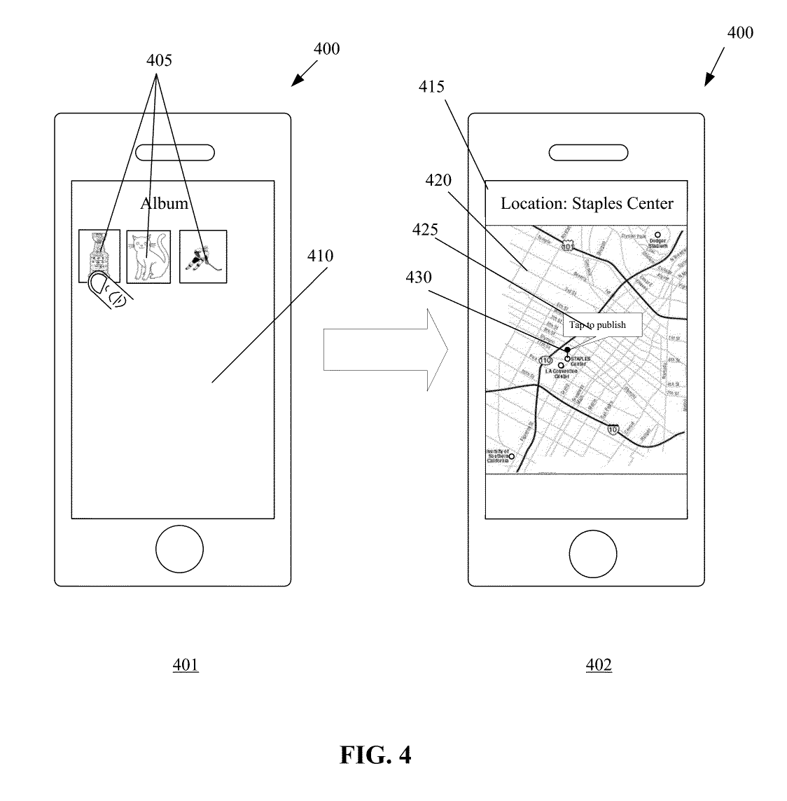

FIG. 4 illustrates an exemplary display on a mobile device 400 for providing content to the content broadcasting service. Using the mobile device 400, a user may log into the content broadcasting service using a previously created account and post content to the service using the account. FIG. 4 illustrates two stages 401 and 402 of a user's interaction with the content broadcasting service on a mobile device 400. The device display area 410 includes video clip representations 405, location identifier 415, map display 420, content location identifier 430, and UI object 425.

The first stage 401 illustrates an exemplary display 410 of a content album that may be part of the mobile device. For instance, the album illustrated in the first stage may be a functionality that is built into the mobile device. In such instances, the content broadcasting service may link to the mobile device's album by using an Application Programming Interface (API) that enables the client broadcasting service to access different functions of the mobile device. As shown in the first stage 401, a selection of a clip is being received at the mobile device by receiving a gestural interaction with one of the content representations 405. Such gestures may include tapping the screen on or around the content representation 405.

The second stage 402 illustrates a display similar to that of the mobile device 100 in FIG. 1. As shown, the location indicator 415 is providing information as to the location of the mobile device. The location indicator provides information about the geographic location to which the content being posted will be associated. Map display 420 displays a map of the general area about which the mobile device is located. Content location identifier 430 further defines the location of the mobile device 400 and the location to which the content will be posted. The location of the mobile device and association with the content is important because it may be used to exclude mobile devices beyond a radius from the geographic location from accessing the content However, as discussed previously, mobile devices that are within the geographic radius may still be excluded from accessing the content when other criteria is not met such as timing and behavioral patterns.

The UI object 425 in this exemplary display provides instructions for publishing the content to the content broadcasting service at the geographic location pinpointed on the map. The content may be provided to the content broadcasting service when the mobile device 400 receives a gestural action from the user such as a tap of the display on or around the content location indicator 430. However, other actions may be suitable for initiating publication of the content selected from the first stage 401.

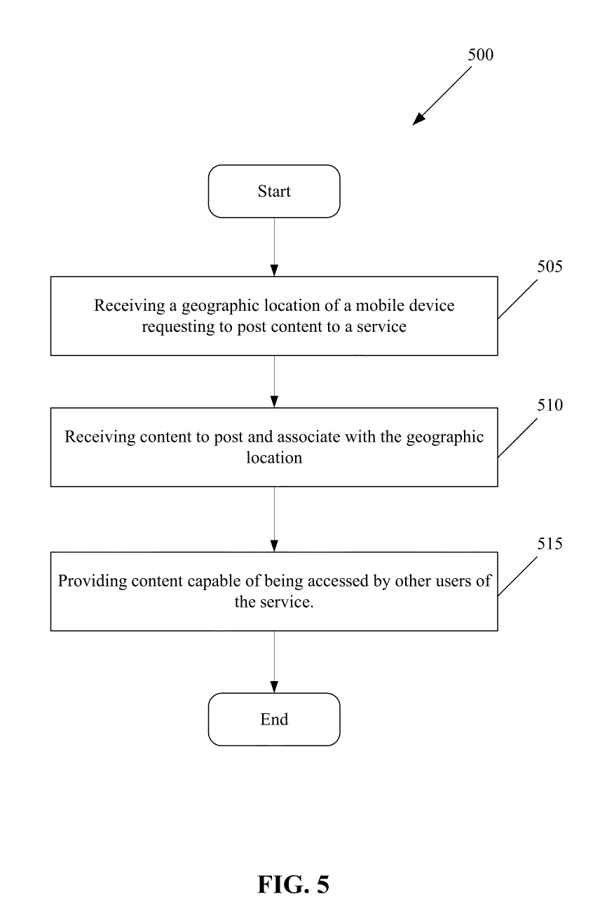

FIG. 5 conceptually illustrates a process 500 for providing content to the content broadcasting service. The process 500 may be run on a content broadcast server. The process 500 may begin after a user has accessed the content broadcasting service through a mobile device.

As shown, the process 500 receives (at 505) a geographic location of a mobile device requesting to post content to a service such as the content broadcasting service. The process 500 receives (at 510) content to post and associate with the geographic location received from the mobile device. As discussed in the foregoing, the geographic location may be determined by a GPS service built into the wireless device. The process 500 provides (at 515) content capable of being accessed by other users of the content broadcasting service. In some aspects of the content broadcasting service, the content is provided, but only accessible by users who are within a specified range of the associated geographic location. In other aspects of the content broadcasting service, the content is only accessible to users within a specified range at a specified time. Additionally, some aspects of the content broadcasting service may only enable access to mobile devices that have performed one or more particular behaviors or actions. Once the content is provided, the process 500 ends. Unlike the process for providing content to the mobile device, providing content to the content broadcasting service may involve permanently storing a copy of the content in permanent storage (e.g., non-volatile memory).

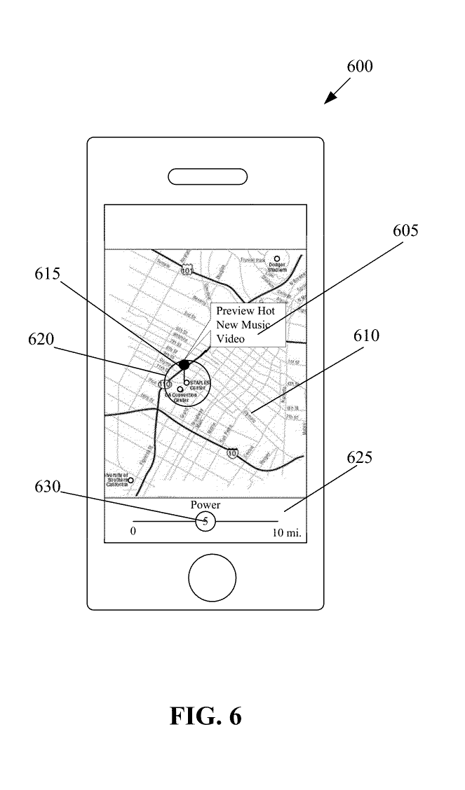

FIG. 6 illustrates an exemplary display of a mobile device 600 that is communicatively connected to the content broadcasting service. The mobile device display includes UI object 605, map display 610, content location indicator 615, radius indicator 620, display region 625, and UI object 630. The map display 610 shows a map of a region. The content location indicator 615 represents a content that is associated with a location on the map pinpointed by the position of the content location indicator 615 on the map display 610. The UI object 605 may display a description of the content associated with the content location indicator. The radius indicator 620 is a circular indicator centered on the content location indicator 615. The radius indicator 620, in connection with the map display 610, represents a geographic region where users of the content broadcasting service may access the content associated with content location indicator 615.

The display on the mobile device 600 also includes a UI object 630 in the display region 625. The UI object 630 of some aspects of the content broadcasting service may be a slidable object 630. In some aspects of the content broadcasting service, the slidable object 630 moves in response to a gestural action such as a touch and drag motion in a horizontal direction. The slidable object 630 controls the size of the access radius defined by the radius indicator 620. For instance, in this example, the access radius is defined at a size of 5 miles. As the slidable object 630 moves in a horizontal direction to the left or right, the access radius decreases or increases in size. The slidable object may be positioned on a scroll bar having a maximum and a minimum radius size. In this example, the minimum radius size is 0 miles and the maximum radius size is 10 miles. However, any minimum and maximum radius sizes may be utilized.

The display of mobile device 600 may be used when the mobile device is or is not at the location indicated by content location indicator 615. For instance, a user may wish to post content for users at a particular location to view. Examples of such content may include, but are not limited to, a sneak preview of a music video for patrons of a particular store, a guided tour of a city where content is accessible at different points along the tour, or an amateur video, where a user may wish to limit viewership. Conjunctively, the content broadcasting service may provide the capability of broadcasting that a particular content will be accessible to users of the content broadcasting service who are at a particular location at a particular time. For instance, the content broadcasting service may announce to users that from 3-5 PM on Sunday, a sneak preview of a new music video from a popular artist will be available for any who visits a specific department store. Such a broadcast may be confined geographically to only those mobile devices that are within a specified distance from a location of the specified department store, while devices outside of the specified distance or timeframe may be excluded from accessing the content. Conversely, such a broadcast may be distributed to all users of the content broadcasting service. Configuring broadcast message feature of the content broadcasting service will be discussed in greater detail in the following figure.

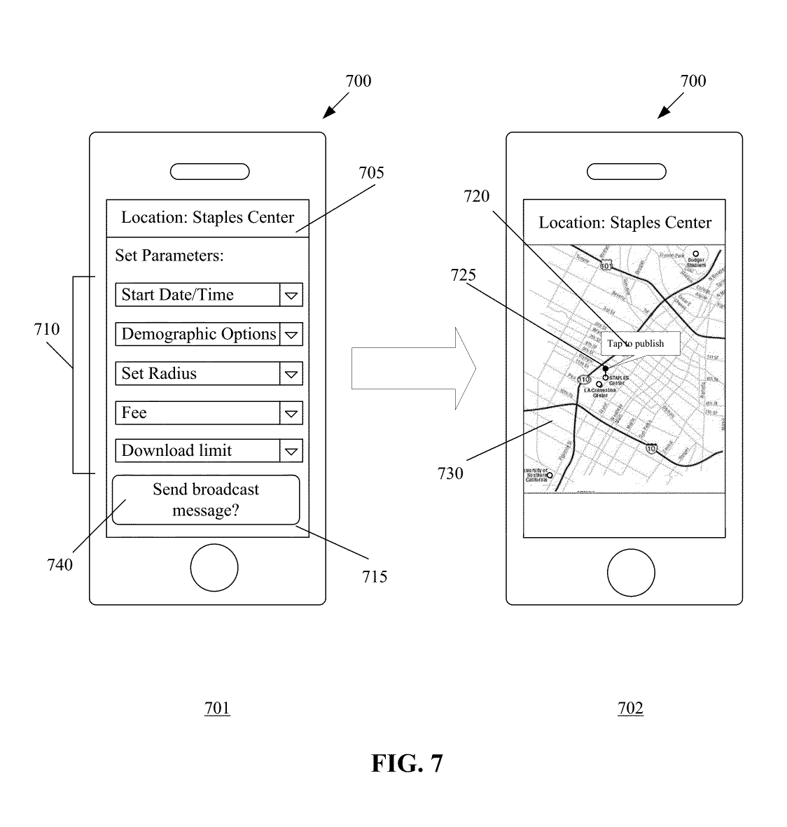

FIG. 7 illustrates an example display of a mobile device 700 for setting different parameters or criteria defining which users of the content broadcasting service are able to access the content. Using the mobile device 700, a user may log into the content broadcasting service using a previously created account and post content to the service using the account. However, in this example, the user may also specify criteria defining how the content is accessed, or more specifically, who can access the content and who is excluded from accessing the content.

FIG. 7 illustrates two stages 701 and 702 of a user's interaction with the content broadcasting service on a mobile device 700. The mobile device includes a display having a set of selectable criteria 710, a location indicator 705, content locating identifier 725, map display 730, display 715, UI object 720, and UI object 740.

The first stage 701 may display upon receiving an interaction from a user to post content associated with a particular location. The particular location may be the location of the mobile device or it may be a location received by user input from the user of the device. The received location may or may not be the current location of the mobile device. In this example, the location associated with the content to be published is indicated by the location indicator 705.

The first stage 701 also displays different criteria 710 to be set by receiving user interaction with the drop down objects and the UI object 740, which when selected may cause new options to display in display 715 for defining whether a message about when and where the content will be accessible should be provided to some or all of the users of the content broadcasting service. For instance, the content broadcasting service could be configured to transmit one or more messages to draw users of the content broadcasting service to a particular location by enticing the users with the prospect of accessing a content that may be a special never before seen preview. The one or more messages could include information about when and where the content will be available and how to access it. For example, a special access code may be required to access the content. If the content is going to be made available at a department store, the department store may require a behavioral action such as a purchase of a specified amount be made in order to obtain the access code. The content broadcasting service may require that such behavioral actions occur during a certain time period in order to enable content access.

Although this example provides several drop down options for setting the criteria, the criteria may be displayed and/or selected using any number of different display options such as text boxes for receiving user input of text, radio buttons, scrollable lists or any other suitable UI object. The criteria, in this example, may be set based on receiving a gestural interaction with the display 715.

The second stage 702 illustrates a mobile device 700 after the content broadcasting service has received instructions from the mobile device 700 to set the criteria specified in the display 715 of the first stage 701. As shown in the second stage 702, a content location identifier 725 is placed at the location on the map display 730 that represents the location associated with the content. UI object 720 provides instructions for how to publish the content to the content broadcasting service. In this example, UI object 720 indicates that a gestural motion such as tapping on or around the content location identifier 725 received at the mobile device 700 will cause the content to publish to the content broadcasting service along with the associated criteria provided in the first stage 701.

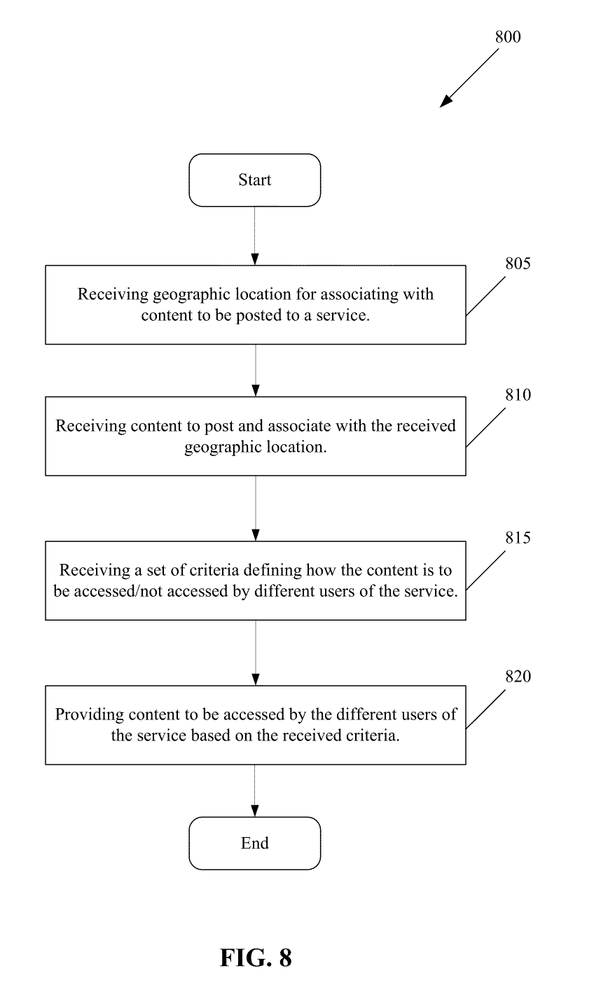

FIG. 8 conceptually illustrates a process 800 for providing content to the content broadcast service. The process 800 may be performed by a content broadcasting server. The process 800 may begin after a user has logged into the content broadcasting service from a device such as a mobile device or any other device capable of accessing the internet.

As shown, the process 800 receives (at 805) geographic location information for associating with content to be posted to a service such as the content broadcasting service. In some aspects of the content broadcasting service, the geographic location information may be received from a mobile device accessing the content broadcasting service that is communicatively connected to a GPS service. The GPS service may provide the location information. In other aspects of the content broadcasting service, the location may be received as user input from a user inputting location information. In such aspects, the user inputting the location information may not be physically located at the received location.

The process 800 receives (at 810) content to post and associate with the received geographic location. The content may be posted to the content broadcasting service. The process 800 receives (at 815) a set of criteria defining how the content is to be accessed by different users of the service. For instance, the process 800 may receive a geographic viewing/access radius defining that users that are within a given distance may access the content. Optionally, the process 800 may also receive additional criteria such as the date and time that the content will become available and the date, time that the content will become unavailable, and certain behavioral actions that the device must perform before the content becomes available. Devices may be excluded from accessing the content, even if within the geographic range, if at least one specified criteria is not met

Additionally, the process 800 may receive criteria for restricting content access such as demographic information, number of times the content may be accessed, proximity to the content, time of availability, and mobile carriers for defining users that may access the content. In some aspects of the content broadcasting service, the process 800 may receive information about a fee to charge users who would like to access the content. In such aspects, only users who pay the requisite fee would be permitted to access the posted content. By specifying different criteria, the content broadcasting service may be used for targeting certain users for targeted and intelligent advertising, in some aspects of the mobile broadcasting service.

The process 800 then provides (at 820) content to be accessed by the different users of the service based on the received criteria. Specifically, some aspects of the content broadcasting service may only permit users who fit, and exclude users who don't fit, the specified criteria to access the content or see a visual indication that the content is available for the user to access. Once the content is posted, it may only be accessed by users or mobile devices that satisfy the criteria received when the content was posted to the content broadcasting service.

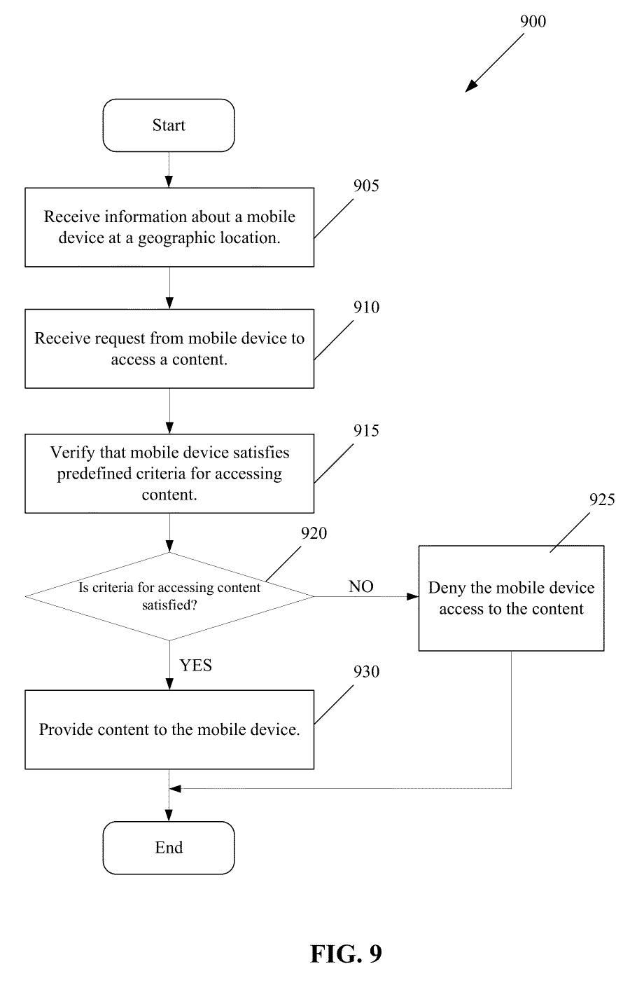

FIG. 9 conceptually illustrates a process 900 for providing content to a mobile device that satisfies predefined criteria. The process 900 may be performed, for example by a content broadcasting server. The process 800 may begin after a user has logged into the content broadcasting service from a device such as a mobile device or any other device capable of accessing the internet.

As shown, the process 900 receives (at 905) information about a mobile device at a geographic location. For instance, the process 900 may receive information about a mobile device that is at a geographic location that is near a location associated with a particular posted content.

The process 900 receives (at 910) a request from the mobile device to access a content. For instance, the mobile device may attempt to access a content associated with a location that is near the location of the mobile device. This particular content may have been posted to the content broadcasting service along with a set of criteria such as those discussed with respect to FIG. 7. In such instances, the content broadcasting service will need to first verify that the mobile device satisfies the criteria specified when the content was posted.

At 915, the process 900 verifies the mobile device satisfies the predefined criteria for accessing the content. For instance, when the mobile device was registered with the content broadcasting service, demographic information about the user of the mobile device may have been provided to the content broadcasting service. In such instances, the content broadcasting service may analyze the criteria associated with the content that the mobile device wishes to access and determine if it the demographic information associated with the mobile device fit the criteria.

However, the process 900 is not limited to only demographic information. Other information could also be considered in verifying that the mobile device satisfies the criteria for accessing the content. Such information may include the number of the times that the content has been accessed. For example, if the content has been accessed more than a defined threshold number of times, the content broadcasting service may determine that the mobile device does not satisfy the criteria for accessing the content. Other criteria may include telecommunications providers, proximity of the device to the location associated with the content, and mobile device manufacturer. Further criteria may include the criteria discussed above such as timing and behavioral patterns.

The process 900 determines (at 920) whether the criteria for accessing the content is satisfied. When the process 900 determines that the criteria for accessing the content has been satisfied, the process 900 provides (at 930) the content to the mobile device. When the process 900 determines that the criteria for accessing the content has not been satisfied, the content denies (at 925) the mobile device access to the content. As discussed above, access may be provided by a temporary dynamic link to the content on the content broadcasting service. Once access to the content has been provided or denied, the process ends.

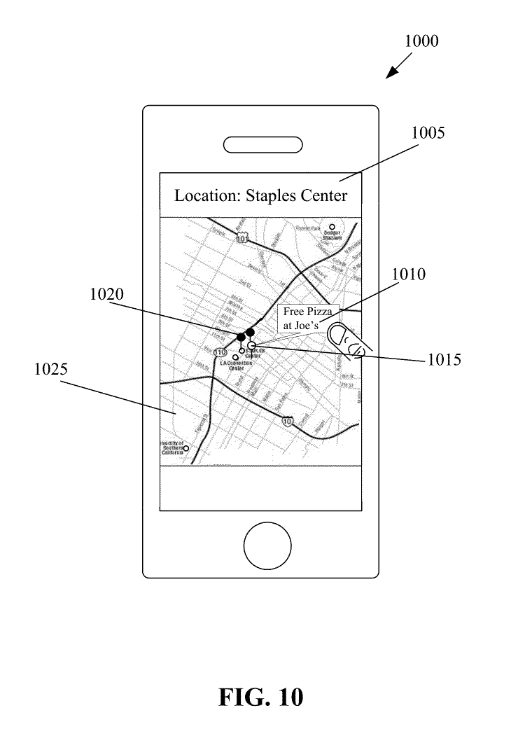

FIG. 10 illustrates an exemplary mobile device 1000 having a display. The device display includes location indicator 1005 and map display 1025. The map display includes content location indicators 1020 and 1015, and UI object 1010.

As shown, the content location indicators 1020 and 1015 may have different visual indicators. Specifically, the visual indicators may be of different colors. The different visual indicators are used to differentiate advertising content from other content. For instance, visual indicator 1015 may indicate advertising content associated with a particular location such as the location specified by location indicator 1015. The advertisement may be accessible to users using the content broadcasting service that are within a given range of the map location indicated by content location indicator 1005. UI object 1010 may indicate more information about the content associated with content location indicator 1015. For instance, content location indicator 1015 may be an advertisement placed by a pizza shop. By tapping on or around the UI object 1010 or content location indicator 1015, the mobile device may be provided with a coupon for a free pizza at the pizza shop. The ability to place visually identifiable advertising content provides the capability to place targeted advertisements based on location and other criteria such as demographics and the criteria discussed with respect to the first state 701 of FIG. 7.

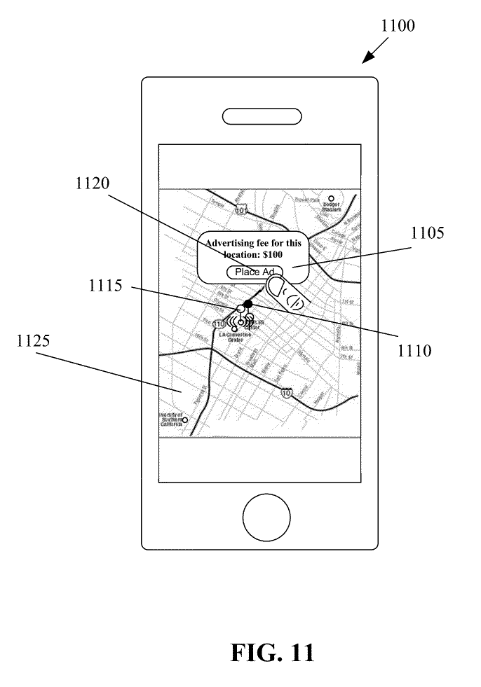

FIG. 11 illustrates an exemplary mobile device 1100 having a display for placing a targeted advertisement using the content broadcasting system. The mobile device 1100 includes a map display 1125. The map display includes content location identifiers 1115 and 1120. And selectable UI objects 1105 and 1120.

As shown, the map includes two content location identifiers 1115 and 1110, which are visually different. For instance, content location identifier 1115 represents a location for advertising content, while content location identifier 1110 represents a location for other content. In this exemplary display, the device may have received user input to associate an advertising content with a location on the map. Content location indicator 1115 represents that location and as illustrated, the content may be placed on the map at a location corresponding to the associated location. Upon placement, UI object 1105 may display. UI object 1105 indicates that placing an ad at the associated location would cost $100. If this fee is satisfactory, the mobile device may receive a user interaction at or around the UI object 1120 to place the ad for the provided fee.

However, if the proposed fee is not suitable, the mobile device may display other options for increasing or decreasing the cost. Such options may be displayed in a different display (not shown) having slidable objects, which are associated with a geographic range from the location. For instance, as the slidable object moves in a horizontal direction, the proposed price may decrease as the miles away from the location increase. Additionally, slidable objects may be used for duration of the advertisement. For instance, as the slidable object moves horizontally, the duration of the advertisement post may decrease. Furthermore, the cost of the advertisement could be tied to the criteria shown in FIG. 7 such as the timing of the advertisement. For instance, if an advertisement is set to start around the same time a special event will start or end, the cost of placing the advertisement may increase. As the event draws closer in time, the cost of the advertisement may also increase, creating an incentive for anyone wishing to place an advertisement to do so quickly. Thus, the content broadcasting service provides an option for monetizing advertising content, which dynamically adjusts due to fluctuations in the environment around the location associated with the advertisement and advertising criteria received from a mobile device.

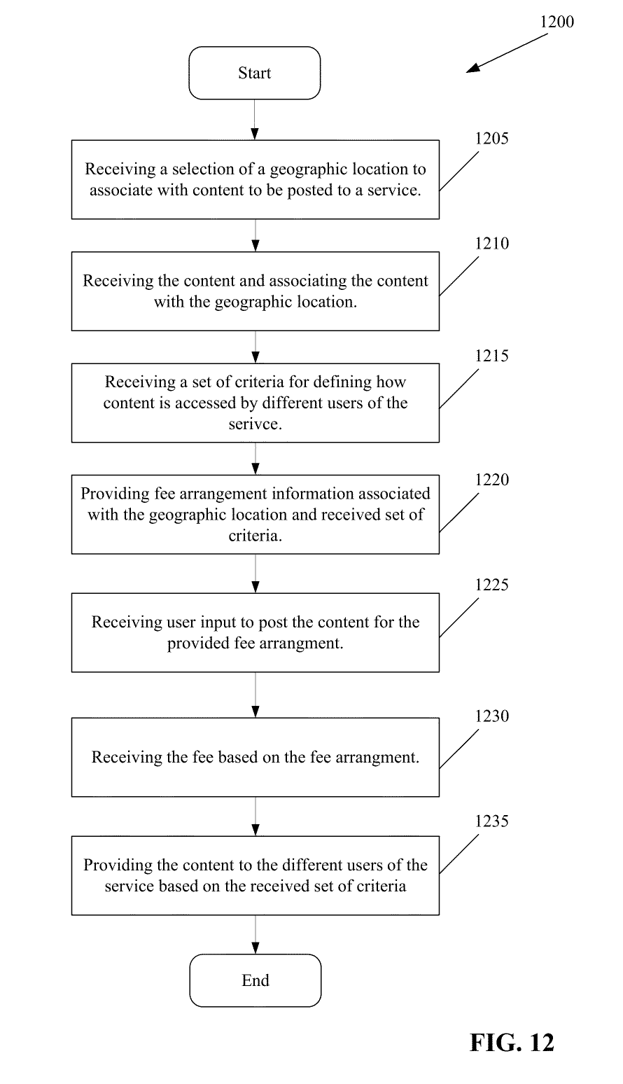

FIG. 12 conceptually illustrates a process 1200 for providing content to the content broadcasting service. The process 1200 may be performed by a content broadcasting server. The process 1200 may begin after a user has logged into the content broadcasting service from a mobile device or any device capable of accessing the internet. The process 1200 may be useful in situations where a user wishes to provide advertising content to users of the content broadcast service at a particular location or locations.

As shown, the process 1200 receives (at 1205) a selection of a geographic location to associate with content to be posted to a service such as the content broadcasting service. As will be discussed in greater detail in the following paragraphs, the process 1200 may receive the geographic location from a mobile device that is capable of using a GPS service. The process 1200 may receive the location from the GPS service, which may correspond to the location of the mobile device. In some aspects of the content broadcasting service, the location may be received as user input from a user inputting location information. In such aspects, the user inputting the location information may not be physically located at the received location.

The process 1200 receives (at 1210) the content and associates (at 1210) the content with the geographic location. The process 1200 receives (at 1215) a set of criteria for defining how content is accessed by different users of the service. Such criteria may be the criteria discussed with respect to FIGS. 7 and 8. For example, the criteria may include date, time, and duration that the content is accessible to different users of the content broadcasting service.

At 1220, the process 1200 provides fee arrangement information associated with the geographic location and the received set of criteria. For instance, the process 1200 may provide different fee terms that depend on the proximity and duration of a geographic placement of content in relation to particularly popular location such as a stadium or fair. In such instances, the content broadcasting service may charge a higher fee for content that is placed closer to a stadium during, and for a period of time before and after, a scheduled game. Such fee arrangements may only be directed to advertising content which uses a visual indicator that is different from non-advertising content. The process 1200 receives (at 1225) user input to post the content for the provided fee arrangement.

The process 1200 receives (at 1230) the fee based on the fee arrangement. In some aspects of the content broadcasting service, the fee may be received from an account set up by the user prior to providing the content. In other aspects of the content broadcasting service, the fee may be received through some other transaction such as a credit card transaction which may be stored on the content broadcasting server or input at the time of receiving the user input to post the content.

At 1235, the process 1200 provides the content to the different users of the service based on the received set of criteria. For example, the process 1200 may provide the content for a specified duration and that is only accessible to users that are within a particular proximity of the geographic location associated with the content. The geographic location of the user, in some aspects of the content broadcasting service may be received from a GPS enabled mobile device carried by the user. The content provided to the content broadcasting service using the process 1200 may be then provided to a mobile device using the process 900 described with respect to FIG. 9.

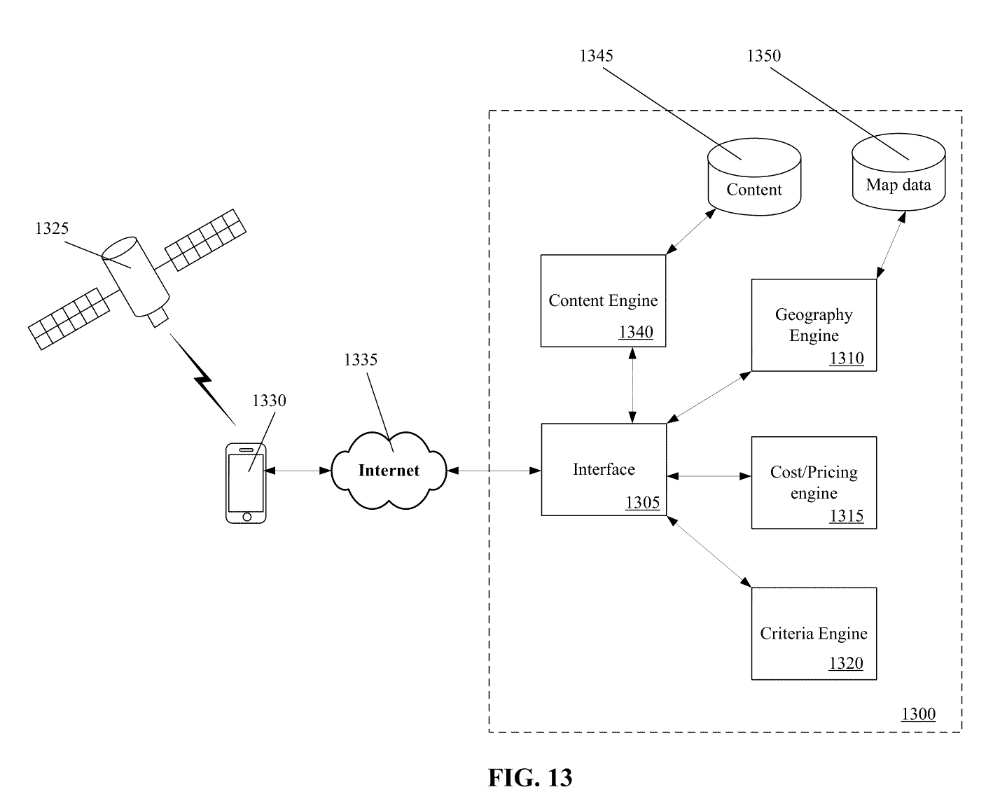

FIG. 13 illustrates an exemplary configuration of a content broadcasting server 1300. The content broadcasting server is communicatively coupled to a mobile device 1330 by using the internet 1335. The mobile device communicates with a GPS satellite 1325. The content broadcasting server includes an interface 1305, a geography engine 1310, a map data storage 1350, a cost/pricing engine 1315, a criteria engine 1320, a content engine 1340, and content storage 1345.

As shown, interface is communicatively coupled to the content engine 1340. The content engine stores content provided by the mobile device 1330 or any device capable of connecting to the internet (not shown) in the content storage 1345. The content engine 1340 also retrieves content from the content storage when a request to access the content is received from the mobile device 1330.

The geography engine associates a geographic location with the content. The geography engine also retrieves the map data from the map data storage and provides the map data to the mobile device 1330 through the interface 1305. The geography engine may receive a geographic location from the mobile device 1330 (through the interface 1305). The mobile device may be capable of communicating with the GPS satellite 1325 to receive the location information. However, the location information may be acquired through other means such as user input of a location or receiving a location obtained through other services capable of providing a location such as a telecommunications provider.

The criteria engine 1320 associates a set of criteria with content to define how the content is accessed (or not accessed). The criteria engine receives the criteria from the mobile device 1330, which communicates through the interface 1305. The cost/pricing engine 1315 associates a cost with a geographic location and criteria, such as time and duration for accessing content. The cost/pricing information may provide the cost/pricing information to the mobile device 1330 by communication through the interface 1305. The cost/pricing engine may receive the location and criteria information from interface communicating with the mobile device.

Many of the above-described features and applications are implemented as software processes of a computer programming product. The processes are specified as a set of instructions recorded on a machine readable storage medium (also referred to as machine readable medium). When these instructions are executed by one or more computational or processing unit(s) (e.g., one or more processors, cores of processors, or other processing units), they cause the processing unit(s) to perform the actions indicated in the instructions. Examples of machine readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

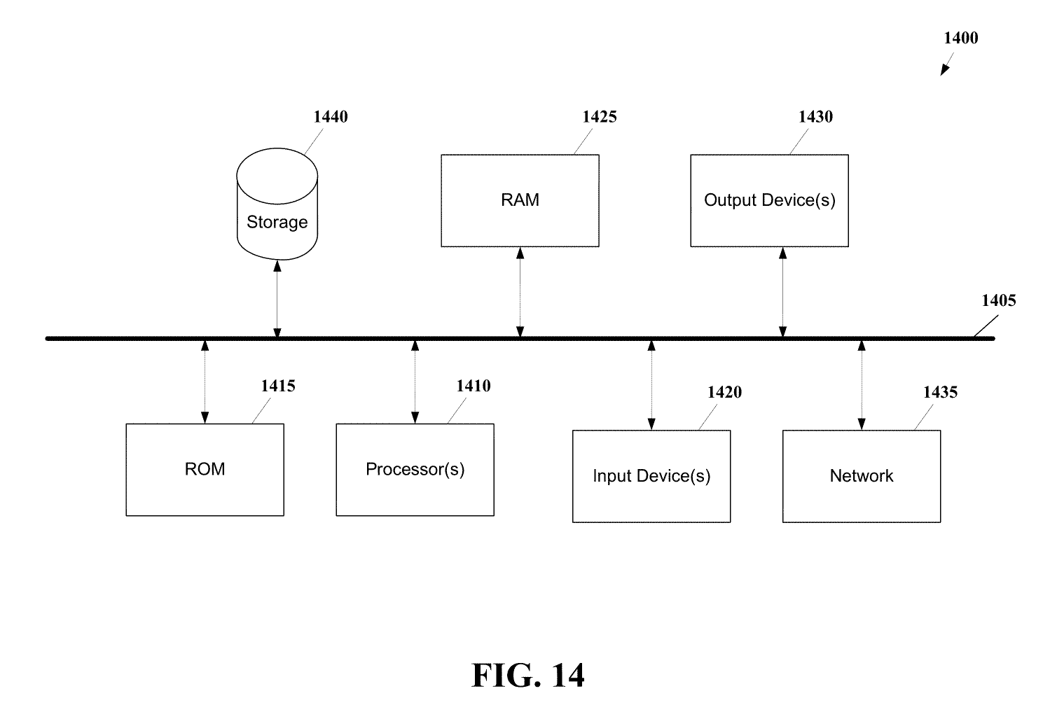

FIG. 14 illustrates an exemplary computer system 1400 that may implement the content broadcasting server. The computer system includes various types of machine readable media and interfaces. The system includes a bus 1405, processors 1410, read only memory (ROM) 1415, input device(s) 1420, random access memory 1425), output device(s) 1430, a network component 1435, and a permanent storage device 1440. The computer system include a computer program product including the machine readable media.

The bus 1405 the communicatively connects the internal devices and/or components of the computer system. For instance, the bus 1405 communicatively connects the processor(s) 1410 with the ROM 1415, the RAM 1425, and the permanent storage 1440. The processor(s) 1410 retrieve instructions from the memory units to execute processes of the invention.

The ROM 1415 stores static instructions needed by the processor(s) 1410 and other components of the computer system. The ROM may store the instructions necessary for the processor to execute the web server, web application, or other web services. The permanent storage 1440 is a non-volatile memory that stores instructions and data when the computer system 1400 is on or off. The permanent storage 1440 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 1425 is a volatile read/write memory. The RAM 1425 stores instructions needed by the processor(s) 1410 at runtime. The bus 1405 also connects input and output devices 1420 and 1430. The input devices enable the user to communicate information and select commands to the computer system. The input devices 1420 may be a keyboard or a pointing device such as a mouse. The input devices 1420 may also be a touch screen display capable of receiving touch interactions. The output device(s) 1430 display images generated by the computer system. The output devices may include printers or display devices such as monitors.

The bus 1405 also couples the computer system to a network 1435. The computer system may be part of a local area network (LAN), a wide area network (WAN), the Internet, or an Intranet by using a network interface. The web service may be provided to the user through a web client, which receives information transmitted on the network 1435 by the computer system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

What is claimed is:

1. A method comprising:
maintaining content and associated geographic information;
receiving a geographic location of a device; and
enabling access of the content to the device based on the geographic information and geographic location of the device.

2. The method of claim 1, further comprising providing the geographic information to the device for displaying a visual representation of the content on a map at a location on the map corresponding to the geographic information.

3. The method of claim 2, further comprising maintaining a plurality of parameters limiting devices that can access the content, wherein the geographic of the content is only provided to devices that satisfy the plurality of parameters.

4. The method of claim 3, wherein the plurality of parameters comprises a viewing radius, and wherein access is only enabled for devices within the viewing radius.

5. The method of claim 4, further comprising associating a cost with the viewing radius, wherein changes the viewing radius cause corresponding changes to the cost.

6. The method of claim 1, further comprising maintaining information about the content for display at the device when receiving user input to access the content.

7. The method of claim 1, wherein enabling access of the content comprises providing a temporary instance of the content to the device.

8. The method of claim 1, further comprising associating a cost with the geographic location.

9. A computer program product comprising a machine-readable medium comprising instructions executable to:
maintain content and associated geographic information;
receive a geographic location of a device; and
enable access of the content to the device based on the geographic information and geographic location of the device.

10. The computer program product of claim 9, wherein the machine-readable medium further comprises instructions executable to provide the geographic information to the device for displaying a visual representation of the content on a map at a location on the map corresponding to the geographic information.

11. The computer program product of claim 10, wherein the machine-readable medium further comprises instructions executable to maintain a plurality of parameters limiting devices that can access the content, wherein the geographic of the content is only provided to devices that satisfy the plurality of parameters.

12. The computer program product of claim 11, wherein the plurality of parameters comprises a viewing radius, and wherein access is only enabled for devices within the viewing radius.

13. The computer program product of claim 12, wherein the machine-readable medium further comprises instructions executable to associate a cost with the viewing radius, wherein changes to the viewing radius cause corresponding changes to the cost.

14. The computer program product of claim 9, wherein the machine-readable medium further comprises instructions executable to maintain information about the content for display at the device when receiving user input to access the content.

15. The computer program product of claim 9, wherein the instructions executable to enable access of the content comprises instructions executable to provide a temporary instance of the content to the device.

16. The computer program product of claim 9, wherein the machine-readable medium further comprises instructions executable to associate a cost with the geographic location.

17. A system comprising:
at least one processor configured to:
maintain content and associated geographic information;
receive a geographic location of a device; and
enable access of the content to the device based on the geographic information and geographic location of the device.

18. The system of claim 17, wherein the processor is further configured to provide the geographic information to the device for displaying a visual representation of the content on a map at a location on the map corresponding to the geographic information.

19. The system of claim 18, wherein the processor is further configured to maintain a plurality of parameters limiting devices that can access the content, wherein the geographic of the content is only provided to devices that satisfy the plurality of parameters.

20. The system of claim 19, wherein the plurality of parameters comprises a viewing radius, and wherein access is only enabled for devices within the viewing radius.

21. The system of claim 20, wherein the processor is further configured to associate a cost with the viewing radius, wherein changes to the viewing radius cause corresponding changes to the cost.

22. The system of claim 21, wherein the processor is further configured to enable access of the content by providing a temporary instance of the content to the device.
